(19) United States
(12) Patent Application Publication
(10) Pub. No.: US 2007/0066480 A1
(43) Pub. Date: Mar. 22, 2007

(54) METHOD OF PREPARING COMPOUNDS USING CAVITATION AND COMPOUNDS FORMED THEREFROM

(76) Inventors: William R. Moser, Hopkinton, MA (US); Oleg V. Kozyuk, North Ridgeville, OH (US); Ivo M. Krausz, Worcester, MA (US); Sean Christian Emerson, Windsor, CT (US); Josef Find, Freising (DE)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(21) Appl. No.: 11/556,019

(22) Filed: Nov. 2, 2006

Related U.S. Application Data
(63) Continuation of application No. 09/761,396, filed on Jan. 16, 2001, now abandoned.
Application No. 09/761,396 is a continuation-in-part of application No. 09/426,254, filed on Oct. 25, 1999, now Pat. No. 6,365,555.

(51) Int. Cl. B01J 23/38

(52) U.S. Cl. 502/346; 502/348

(57) ABSTRACT

Nanostructured materials and processes for the preparation of these nanostructured materials in high phase purities using cavitation is disclosed. The method preferably comprises mixing a metal containing solution with a precipitating agent and passing the mixture into a cavitation chamber. The chamber consists of a first element to produce cavitation bubbles, and a second element that creates a pressure zone sufficient to collapse the bubbles. The process is useful for the preparation of catalysts and materials for piezoelectrics and superconductors.

### RELATED U.S. APPLICATION DATA

This application is continuation of U.S. application Ser. No. 09/761,396 filed on Jan. 16, 2001, which is a continuation-in-part of U.S. patent application Ser. No. 09/426,254 filed on Oct. 25, 1999, now U.S. Pat. No. 6,365,555 issued on Apr. 2, 2002, which claims the benefit of priority from U.S. Provisional Application No. 60/176,116 filed on Jan. 14, 2000. The entire disclosures of these earlier applications are hereby incorporated by reference.

### BACKGROUND OF THE INVENTION

Cavitation is the formation of bubbles and cavities within a liquid stream resulting from a localized pressure drop in the liquid flow. If the pressure at some point decreases to a magnitude under which the liquid reaches the boiling point for this fluid, then vapor-filled cavities and bubbles are formed. As the pressure of the liquid increases, vapor condensation takes place in the cavities and bubbles, and they collapse, creating large pressure impulses and elevated temperatures. Cavitation involves the entire sequence of events beginning with bubble formation through the collapse of the bubbles. Cavitation has been studied for its ability to mix materials and aid in chemical reactions.

There are several different ways to produce cavitation in a fluid. For example, a propeller blade moving at a critical speed through water may result in cavitation. If a sufficient pressure drop occurs at the blade surface, cavitation will result. Likewise, the movement of a fluid through a restriction such as an orifice plate can also generate cavitation if the pressure drop across the orifice is sufficient. Both of these methods are commonly referred to as hydrodynamic cavitation. Cavitation may also be generated in a fluid by the use of ultrasound. A sound wave consists of compression and decompression cycles. If the pressure during the decompression cycle is low enough, bubbles may be formed. These bubbles will grow during the decompression cycle and contract or even implode during the compression cycle. The use of ultrasound to generate cavitation to enhance chemical reactions is known as sonochemistry.

U.S. Pat. Nos. 5,810,052, 5,931,771, and 5,937,906 to Kozyuk, all of which are incorporated herein in their entirety by reference, disclose improved devices and methods capable of controlling the many variables associated with cavitation.

Metal-based materials have many industrial uses. Of relevance are those solid state metal-based materials such as catalysts, piezoelectric materials, superconductors, electrolytes, ceramic-based products, and oxides for uses such as recording media. While these materials have been produced through normal co-precipitation means, U.S. Pat. Nos. 5,466,646 and 5,417,956 to Moser disclose the use of high shear followed by cavitation to produce metal based materials of high purity and improved nanosize. While the results disclosed in these patents are improved over the past methods of preparation, the inability to control the cavitation effects limit the results obtained.

### SUMMARY

One aspect of the present invention is directed to a process for producing metal-based solid state materials of nanostructured size and in high phase purities utilizing cavitation to create high shear and to take advantage of the energy released during bubble collapse.

The process may include the steps of: mixing a metal containing solution with a precipitating agent to form a mixed solution that precipitates a product; passing the mixed solution at elevated pressure and at a velocity into a cavitation chamber, wherein the cavitation chamber has means for creating a cavitation zone and means for controlling said zone, and wherein cavitation of the mixed solution take place, forming a cavitated precipitated product; removing said cavitated precipitated product and the mixed solution from the cavitation chamber; and separating the cavitated precipitated product from the mixed solution. The present invention may employ an apparatus for cavitation such as, for example, the apparatus described in U.S. Pat. No. 5,937,906 to Kozyuk.

The present invention may be suitable for producing nanophase solid state materials such as, for example, metal oxides and metals supported on metal oxides. The synthesis of nanostructured materials in high phase purities is important for obtaining pure metal oxides and metals supported on metal oxides for applications in catalytic processing and electronic and structural ceramics. The synthesis of such materials by cavitation results in nanostructured materials with a high phase purity. While not wishing to be bound to theory, it appears that high shear causes the multi-metallics to be well mixed leading to the high phase purities and nanostructured particles, and the high in situ temperatures results in decomposition of metal salts to the finished metal oxides or metals supported on metal oxides. The present invention may decompose at least some of the metal salts, and preferably all of the metal salts.

These materials may be formed without the requirement of post-synthesis thermal calcination to obtain the finished metal oxides. Conventional methods of synthesis require high temperature calcination to decompose the intermediate metal salts such as carbonates, hydroxides, chlorides, and the like.

The ability to synthesize advanced materials by cavitation requires the equipment used to generate the cavitation to have the capability to vary the type of cavitation that is instantaneously being applied to the synthesis process stream. This “controlled cavitation” permits efficient modification of the cavitational conditions to meet the specifications of the desired material to be synthesized. The method includes the capability to vary the bubble size and length of the cavitational zone, which results in a bubble collapse necessary to produce nanostructured pure phase materials. The bubble collapse may provide a local shock wave and energy release to the local environment by the walls of the collapsing bubbles, which provides the shear and local heating required for synthesizing pure nanostructured materials. The cavitation method enables the precise adjustment of the type of cavitation for synthesizing both pure metal oxide materials as well as metals supported on metal oxides, and slurries of pure reduced metals and metal alloys. A further capability of the method, which is important to the synthesis of materials for both catalysts and advanced materials for electronics and ceramics, is the ability to systematically vary the grain sizes by an alteration of the process conditions leading to cavitation.

Another aspect of the present invention includes the formation of single metal oxides in varying grain sizes of 1-20 nm. Another aspect includes the formation of multi-metallic metal oxides in varying grain sizes and as single phase materials without the presence of any of the individual metal oxide components of the desired pure materials situated on the surface of the desired pure material. Furthermore, the synthesis of reduced metals supported on metal oxides in both grain sizes of 1-20 nm is provided. The capability to vary the grain sizes between 1-20 nm is also possible. Due to these unique capabilities, as compared to conventional methods of synthesis, and compositions formed thereby can function as high quality catalysts, capacitors, piezoelectrics, novel titanias, electrical and oxygen conducting metal oxides, fine grains of slurries of finely divided reduced metals, and superconductors.

### BRIEF DESCRIPTION OF THE DRAWINGS

FIG. 1 illustrates the variation in the strain and grain size of a piezoelectric as a function of orifice size;

FIG. 2 illustrates an XRD comparison of a piezoelectric prepared according to the present invention and by classical preparation;

FIG. 3 illustrates the XRD of finely dispersed silver on aluminum oxide synthesized in accordance with the present invention;

FIG. 4 illustrates the effect of high pressure versus low pressure in the cavitation process of the present invention on the synthesis of Cu_{0.22}Zn_{0.68}Al_{0.1}Oₓ;

FIG. 5 illustrates the effect of high pressure versus low pressure in the cavitation process of the present invention on the synthesis of Cu_{0.22}Zn_{0.68}Al_{0.1}Oₓ with regard to crystallographic strain (%) versus grain size (nm);

FIG. 6 illustrates the effect of high pressure versus low pressure in the cavitation process of the present invention on the lattice distortion of Cu_{0.22}Zn_{0.68}Al_{0.1}Oₓ as it relates to the c-Axis versus orifice size;

FIG. 7 illustrates the relative intensity of 2% Pd formed by the cavitation process of the present invention followed by calcination at 1095° C.

### DETAILED DESCRIPTION

The apparatus utilized in the present invention can include, for example, a pump to elevate the pressure of the liquid being fed to the apparatus and a cavitation zone within the apparatus. The cavitation zone includes a flow-through channel having a flow area, internally containing at least one first element that produces a local constriction of the flow area, and having an outlet downstream of the local constriction; and a second element that produces a second local constriction positioned at the outlet, wherein a cavitation zone is formed immediately after the first element, and an elevated pressure zone is created between the cavitation zone and the second local constriction.

The liquid may be pressurized prior to entering the flow-through channel. A local constriction in the channel creates an increase in the velocity of the liquid flow to some minimum velocity, creating a sufficient pressure drop to allow cavitation to occur. On average, and for most hydrodynamic liquids, the minimum velocity is 16 m/sec or greater.

The element(s) producing the local constriction may take many different shapes such as, for example, a cone, or spherical or elliptical shape, and can be located in the center of the flow channel. Suitable elements may include, for example, a crosshead, post, propeller, nozzle, or any other fixture that produces a minor loss in pressure, such as one or more orifices or baffles. By varying the size of the orifice, the apparatus is able to better control the size of the cavitation bubbles being formed. The orifice may have one or more circular or slotted openings.

The cavitation bubbles are transported by the flow of liquid into a cavitation zone. The cavitation bubbles flow with the liquid into an elevated pressure zone. A second element may be placed in the flow channel downstream of the cavitation zone, creating a back pressure to form the elevated pressure zone. The second element may also take many shapes, but an element similar in operation to a control valve is preferred. By controlling the pressure in this zone, the apparatus is able to determine the length of the cavitation zone and determine when bubble collapse will occur. Upon entering the elevated pressure zone, the cavitation bubbles collapse, resulting in high pressure implosions with the formation of shock waves that emanate from the point of each collapsed bubble. Under the high temperatures and pressures caused by bubble collapse, the liquid on the boundary of the bubble, and the gas within the bubble itself, undergo chemical reactions, the nature of which depends on the materials in the feed. These reactions may be oxidation, disintegration or synthesis, to name a few.

In another embodiment, the second element may be the first element of a second cavitation zone. In this manner, two or more cavitation zones may be placed in series to produce a multi-stage apparatus. Each cavitation zone may be controllable depending on the first element selected for the next cavitation zone, the distance between each first and second element, and the final second element at the end of the multi-stage apparatus.

In yet another aspect of the invention, the second element may be as simple as an extended length of the channel, a turn or elbow in the channel, or another piece of processing equipment. The second element provides some back pressure to create the cavitation and elevated pressure zones.

The desired cavitated products are removed from the liquid by suitable separation techniques, such as, for example, vacuum filtration, gravity filtration, or evaporation. Prior to, or after removal, of the cavitated products, the liquid may be recycled back to the cavitation chamber. Recycle of the unfiltered product may occur many times. Where multi-stage cavitation chambers are used, recycle may be to one or more of the chambers. As the length of the period of recirculation increases, the resulting final product may have a higher degree of phase purity and smaller particle size.

The nanostructured materials provided in accordance with the present invention typically prepared by precipitation of the desired product from a metal containing solution. The metal containing solution may be aqueous or non-aqueous (e.g., organic). At least one component of the metal containing solution may be in a liquid state and be capable of creating cavitation. Other components may be different liquids, solids, gases, or mixtures thereof. The liquid component may be materials commonly thought of as liquids, or the final component may also be materials commonly thought of as solids or gases, but being processed in their liquid state, such as, for example, molten metals and molten minerals having sufficiently low vapor pressure to generate bubbles.

Metals may be in the form of salts. Examples of suitable salts. However, in the case of certain precious metals the metal may be added in the form of an acid such as chloroplatinic acid include nitrates, sulfates, acetates, chlorides, bromides, hydroxide, oxylates, and acetylacetonates. The metal may be, for example, cobalt, molybdenum, bismuth, lanthanum, iron, strontium, titanium, silver, gold, lead, platinum, palladium, yttrium, zirconium, calcium, barium, potassium, chromium, magnesium, copper, zinc, and mixtures thereof, although any other metal may find use in the present invention.

Metal salts may be purchased as such, or may be prepared by any method known to those skilled in the art. For example, iron oxide may be made from ferric nitrate hydrate; barium titanate may be made from a mixture of barium acetate in water and titanium tetraisopropoxide in isopropyl alcohol; and a ceramic such as lanthana may be made from lanthanum nitrate. Complex metal catalysts such as iron bismuth molybate may be formed utilizing the appropriate metal salts.

Metals typically suited for piezoelectric materials are lanthanum, titanium, gold, lead, platinum, palladium, yttrium, zirconium, zinc, and mixtures thereof. Metals typically suited for superconductors are strontium, lead, yttrium, copper, calcium, barium, and mixtures thereof.

The solution into which the salt is dissolved will depend upon the particular metal salt. Suitable solvents include water, aqueous nitric acid, alcohols, acetone, hydrocarbons, and the like.

The liquid that causes the desired metal salt to precipitate from solution due to insolubility of the metal salt in the liquid may be used as a precipitating agent. Suitable precipitating agents may include any suitable base such as, for example, sodium carbonate, ammonium carbonate, potassium carbonate, ammonium hydroxide, alkali metal hydroxide, water (where the metal salt reacts with water), and the like.

In the embodiments where recycling occurs, the pH of the mixed solution may be maintained usually between about 7.5 to about 12. However, the range is dependent on the precise material being synthesized.

In the case of preparing catalysts, a support may be added to the metal containing solution, the precipitating agent or both. Suitable supports may include, for example, alumina, silica, titania, zirconia, and alumino-silicates. The support may also be introduced by adding a corresponding salt, wherein the support itself is then precipitated in the form of nanostructured grains under cavitational conditions. For example, alumina may be introduced by adding aluminum nitrate hydrate.

Zeolites such as ZSM-5, X-Type, Y-Type, and L-Type may be prepared in accordance with the present invention. Metal loaded zeolitic catalysts may contain a metal component such as platinum, palladium, zinc, gallium, copper or iron. The metal salt solution, the precipitating agent, and a silica source may be premixed to form a zeolite gel prior to introduction into the cavitation chamber. Where the gel requires heat to form, the mixture may be recycled in the cavitation chamber until the gel forms and the synthesis results. Alternately, after cavitation, the gel may be placed in a conventional autoclave where a hydrothermal synthesis may be carried out. Finer grain zeolites may result from such a post-cavitation conventional hydrothermal treatment.

The present embodiments have applicability to catalysts, electrolytes, piezoelectrics, super-conductors, and zeolites (as examples of nanostructured materials).

The following examples show the advantages of certain of the present embodiments in the production of nanosized high purity products. Two apparatuses were used in these examples: (1) the Model CaviPro™ 300 (the “CaviPro processor,”) which is a two-stage orifice system operating up to 26,000 psi, with a nominal flow rate of 300 ml/min and up; and (2) the CaviMax™ CFC-2h (“the CaviMax Processor”), which is a single orifice system operating up to 1000 psi, with a nominal flow rate of several liters per minute. Both of these devices are obtainable from Five Star Technologies Ltd, Cleveland, Ohio. Modifications may have been made to the peripheral elements of these devices, such as heat exchangers, cooling jacket, gauges, and wetted materials, depending on the specific application.

### EXAMPLE 1

This example illustrates that controlled cavitation enables the synthesis of an important hydrodesulfurization catalyst for use in the environmental clean-up of gasoline in a substantially improved phase purity as compared to conventional preparations. The preparation of cobalt molybdate with a Mo/Co ratio of 2.42 was carried out in the CaviPro processor. Different orifice sizes were used for the experiment at a hydrodynamic pressure of 8,500 psi. In each experiment, 600 ml of 0.08 M ammonium hydroxide in isopropanol was placed in the reservoir and recirculated. A mixture of 3.43 g (0.012 mol) of CoNO₃. 6H₂O and 5.05g (0.029 mol) (NH₄)₆Mo₇O₂₄. 4H₂O dissolved in 50 ml of distilled water was metered in over 20 minutes. The resulting slurry was immediately filtered under pressure and dried for 10 hours at 110° C. XRD analyses were recorded after air calcination at 325° C.

The conventional preparation of cobalt molybdate with a Mo/Co ratio of 2.42 was carried out in classical synthesis. In each experiment, 600 ml of a 0.08 M ammonium hydroxide in isopropanol solution was placed in a well stirred vessel. A mixture of 3.43 g (0.012 mol) of CoNO₃. 6H₂O and 5.05 g (0.029 mol) (NH₄)₆Mo₇O₂₄. 4H₂O dissolved in 50 ml of distilled water was metered in over 20 minutes. The resulting slurry was immediately filtered under pressure and dried for 10 hours at 110° C. XRD analyses were recorded after air calcination at 325° C.

The XRD pattern of the cavitated and calcined material contains a high intensity peak at 26.6°2θ reflecting the formation of a high fraction of cobalt molybdate. The XRD of materials synthesized by the conventional method demonstrated a much lower intensity peak at 26.6°2θ as well as strong reflections at 23.40 and 25.75°2θ due to separate phase MoO₃. Thus, the exemplary process produced catalyst having a high phase purity, while the classical synthesis failed to produce a catalyst having high phase purity.

### EXAMPLE 2

The catalyst of Example 1 was prepared as in Example 1, at a higher hydrodynamic pressure of 20,000 psig. XRD patterns showed even higher phase purity as compared to the cavitation preparation in Example 1, and much better purity as compared to the classical synthesis.

### EXAMPLE 3

The catalyst of Example 1 was prepared using the CaviMax processor. The orifice used was 0.073 inches in diameter at 580 psig head pressure. The back pressure was varied between 0-250 psig. The phase purity of cobalt molybdate was nearly as high as that observed in Example 2, and much better than that observed in Example 1. The phase purity was much better than the conventional preparation that did not use hydrodynamic cavitation. The XRD data shows that the application of all back pressures resulted in higher purity phase of cobalt molybdate as compared to the conventional preparation.

### EXAMPLE 4

Example 1 was repeated using the CaviMax processor at a pressure of 200-660 psig, and using orifice sizes of 0.073, 0.075, 0.089, and 0.095 inches in diameter. The phase purities of the catalysts were all improved. The use of an orifice diameter of 0.095 inches at 280 psig resulted in a hydrodesulfurization catalyst having the highest phase purity as compared to all of the other diameters.

### EXAMPLE 5

This example illustrates the capability of the present invention to synthesize high phase purities of cobalt molybdate supported on gamma-alumina. The preparation of cobalt molybdate deposited on gamma-alumina with a Mo/Co ratio of 2.42 was carried out in the CaviPro processor. A cavitation generator having 0.009/0.010 inch diameter orifice sizes was used for the experiment at a hydrodynamic pressure range of 4,000, 7,000, and 8,000 psig. In each experiment 600 ml of a solution of 0.0102% ammonium hydroxide in isopropyl alcohol was placed in the reservoir along with 5.0 g of gamma-alumina, and the slurry was recirculated through the processor. While this precipitating agent was recirculated, 0.859 g (0.00295 mol) of Co(NO)₃. 6H₂O and 1.262 g (0.000715 mole) of (NH₄)₆Mo₇O₂₄. 4H₂O dissolved in 50 ml of water was metered in over 20 minutes. After all of the salt solutions had been added, the resulting slurry was recirculated through the processor for an additional 5 minutes. The slurry was immediately filtered under pressure and dried for 10 hours at 110° C. XRD analyses were recorded after air calcination at 350° C. for four hours.

At all pressures, the experiment resulted in superior phase purities of the active hydrodesulfurization catalyst precursor, cobalt molybdate, as compared to the conventional synthesis of the same catalyst. In addition, for this catalyst, the optimum conditions for the generation of the smallest nanostructured grains of the catalyst resulted from the low pressure, 4,000 psig synthesis.

### EXAMPLE 6

The catalyst of Example 5 was prepared using silica in place of alumina. The preparation of cobalt molybdate deposited on Cabosil (silica) with a Mo/Co ratio of 2.42 was carried out in the CaviPro processor. Different orifice sizes were used for the experiment at a hydrodynamic pressure range of 10,000 psig. In each experiment 600 ml of 0.0102% ammonium hydroxide in isopropyl alcohol was placed in the reservoir, along with 5.0 g of Cabosil, and the slurry was recirculated through the processor. While this precipitating agent was recirculated, 0.859 g (0.00295 mol) of Co(NO)₃. 6H₂O and 1.262 g (0.000715 mol) of (NH₄)₆Mo₇O₂₄. 4H₂O dissolved in 50 ml of water was metered in over 20 minutes. After all of the salt solutions had been added, the resulting slurry was recirculated through the processor for an additional 5 minutes. The slurry was immediately filtered under pressure and dried for 10 hours at 110° C. XRD analyses were recorded after air calcination at 350° C. for four hours.

The cavitational synthesis resulted in higher phase purity for cobalt molybdate deposited on silica as compared to the conventionally prepared catalyst. The use of a 0.006 and 0.014 inch diameter orifice set led to finer nanostructured grains of the catalyst.

### EXAMPLE 7

Beta-bismuth molybdate (Bi₂Mo₂O₉) was also synthesized in accordance with the present invention. Bi₂Mo₂O₉ is typical of the family of catalysts used for hydrocarbon partial oxidations, such as the conversion of propylene to acrolein or ammoxidation of propylene to acrylonitrile. This synthesis used the CaviMax processor with four different orifice sizes in a low pressure mode. The synthesis of this material was carried out as follows. 450 ml of isopropyl alcohol was used as the precipitating agent, and was placed in the reservoir. While this precipitating agent was recirculated, 12.83 g (0.0264 mol) of Bi(NO₃)₃. 5H₂O dissolved in 50 ml of 10% HNO₃, and 4.671 g (0.00378 mol) of (NH₄)₆Mo₇O₂₄. 4H₂O dissolved in 50 ml of distilled water was metered in over 20 minutes. After all of the salt solutions had been added, the resulting slurry was recirculated through the processor for an additional 2 minutes. The slurry was immediately filtered under pressure and dried for 10 hours at 110° C. XRD analyses were recorded after air calcination at 350° C.

TABLE 1
Variation of Grain Sizes

| Orifice Diameter | |
|---|---|
| (in.) | Grain Size (nm) |
| 0.073 | 21 |
| 0.081 | 28 |
| 0.089 | 22 |
| 0.095 | 11 |

The cavitational syntheses resulted in very pure phase beta-bismuth molybdate. Furthermore, the XRD patterns showed that the grain size of the particles could be varied over a wide range of nanometer sizes by changing the orifice sizes. Since it is well known in the catalytic literature that nanometer grains of catalysts often result in greatly accelerated reaction rates, the capability of the cavitational syntheses to vary this grain size is of general importance to several catalytic reactions other than hydrocarbon partial oxidation.

### EXAMPLE 8

This example shows that the present invention can also be applied to the synthesis of complex metal oxides such as perovskites and ABO₃ metal oxides results in unusually high phase purities. The synthesis of La_{.7}Sr_{.3}FeO₃ was performed using the CaviMax processor and using orifice sizes of 0.073, 0.081, 0.089, and 0.095 inch diameter. 600 ml of a 1 M solution of Na₂CO₃ in distilled water was placed in the reservoir, and the slurry was recirculated through the processor. While this precipitating agent was recirculated, La(NO₃)₃6H₂O (7.999 g, 0.0185 mol), Fe(NO₃)₃. 9H₂O (10.662 g, 0.0264 mol) and Sr(NO₃)₂ (1.6755 g, 0.00792 mol) were dissolved in 100 ml of distilled water and this solution was metered in over 20 minutes. After all of the salt solutions had been added, the resulting slurry was recirculated through the processor for an additional 5 minutes. The slurry was immediately filtered under pressure and dried for 10 hours at 110° C. XRD analyses were recorded after air calcination at 600° C.

The XRD data demonstrates that an orifice size of 0.095 inches diameter results in the synthesis of nanostructured pure phase perovskite, La_{0.8}Sro_{0.2}Fe_{1.0}O_{3.0-x}, as a nanostructured material of 18 nm, and the phase purity was much better than that attainable by the conventional synthesis. Parallel experiments using the CaviPro processor using orifice sets of 0.006/0.008, 0.006/0.010, 0.006/0.012 and 0.006/0.014 inch diameter all resulted in high phase purities of the desired perovskite. These results were superior to both the CaviMax and conventional synthesis. Potential applications of this type of perovskite material include CO oxidation in automotive exhaust emissions applications; solid state oxygen conductors for fuel cell applications; and dense catalytic inorganic membranes used for oxygen transportation in the reforming of methane to syngas.

### EXAMPLE 9

This example shows that strain can be systematically introduced into a solid state crystallite by use of the present embodiments. Titanium dioxide was prepared using the CaviMax processor. The effect of strain introduced into the TiO₂ crystal as a function of orifice size of the cavitation processor was examined. In this synthesis, 100 g (0.27664 mol) of titanium butoxide was mixed with 2-propanol to give a volume of 0.5 L in a glove-box under nitrogen. This process yielded a clear yellowish solution, which is stable in air. 750 ml of deionized water was placed in the reservoir of the CaviMax processor and circulated. 75 ml of the titanium butoxide/2-propanol solution was added slowly with a feed rate of 4 ml/minute. The solution with the precipitated TiO₂ was circulated for an additional 17 minutes. The slurry was filtered at 100 psi. The filtrate was dried at 100° C. for 2 hours and then calcined at 400° C. for 4 hours. The XRD data were taken after air calcination and the percent strain was estimated using the Williamson-Hall method.

TABLE 2
Crystallographic Strain

| Orifice | |
|---|---|
| Size (inches) | Strain % |
| 0.073 | 0.26 |
| 0.081 | 0.23 |
| 0.089 | 0.26 |
| 0.095 | 0.29 |
| 0.105 | 0.32 |
| 0.115 | 0.33 |
| 0.230 | 0.43 |

As shown in Table 2, the larger the orifice size, the larger the crystallographic strain (i.e., the strain that the crystal suffers as a result of the crystal's lattice distortion) in the particles [from 0.2% prepared with a small orifice (0.073 inches diameter) to 0.35% prepared with a large orifice (0.115 inches diameter)]. The ability to systematically alter crystallographic strain within a particle is important, since crystallographic strain affects the chemical potential of the surface atoms. Applications of this type of control include the application of these materials as photocatalysts and as optical absorbers.

### EXAMPLE 10

The synthesis of 20% w/w silver on titania was examined as a function of orifice size, and the results were compared to the conventional synthesis of such metal supported materials. 1 L of deionized water was recirculated in the CaviMax processor equipped with a 0.075 inch diameter orifice. A 100 ml solution of titanium (IV) butoxide in isopropyl alcohol (0.63 mol/L Ti) was added to the CaviMax processor at 4 ml/min to form a precipitate. The total time of precipitation plus additional recirculation was 30 minutes. Two solutions were added simultaneously to the recirculating, precipitated titanium slurry. The first solution consisted of a 250 ml silver solution of silver acetate (AgOOCCH₃) in deionized water (0.046 mol/L Ag), which was added at a rate of 10 ml/min. The second feed was a 250 ml solution of hydrazine in water (0.70 mol/L N₂H₄), such that the N₂H₄/Ag molar ratio was 15.0, which was added at a rate of 10 ml/minute. The total time of addition plus additional recirculation was 30 minutes. The product was filtered, washed with water to form a wet cake, and dried in an oven at 110° C. A portion of the dried product was calcined in air for 4 hours at 400° C. A portion of the dried product was submitted for x-ray analysis and identified as silver on an amorphous titania support. X-ray line broadening analysis indicated that the mean silver grain size was 7.4 nm. A portion of the calcined product was submitted for x-ray analysis and identified as silver on titania. All of the titania was identified as anatase, while no rutile was observed. X-ray line broadening analysis indicated that the mean silver grain size was 12 nm. The conventional synthesis was performed as above except in a stirred 1500 ml beaker.

The grain sizes of the silver particles after drying the samples at 110° C. are shown in Table 3. This example shows that metallic particles deposited on reactive supports such as titania can be synthesized in smaller grain sizes as compared to parallel conventional synthesis. Furthermore, when the catalysts were calcined to 400° C. in air, the silver particles deposited on the conventional catalyst grew to a much larger size than those deposited by cavitational techniques. These types of materials are important as photocatalysts for the destruction of toxins in waste chemical streams.

TABLE 3
Grain Size of 20% w/w Silver on Titania

| | Grain size, | Grain Size, Calcined |
|---|---|---|
| | dried (nm) | 400° C. (nm) |
| Conventional | 7.6 | 20.1 |
| Precipitation-Deposition | | |
| CaviMax 0.115 orifice | 4.7 | 13.4 |
| CaviMax 0.073 orifice | 7.4 | 12.0 |

### EXAMPLE 11

2% w/w silver was synthesized on alpha-alumina using both a cavitational synthesis and a conventional synthesis. The synthesis of this material was carried out as follows.

A slurry consisting of 5.00 g of aluminum oxide (alpha, Al₂O₃) in 1 L deionized water was recirculated in the CaviMax processor equipped with a 0.073 inch diameter orifice. Two solutions were added to the recirculating aluminum oxide slurry. The first solution consisted of a solution of silver acetate and ammonium hydroxide in deionized water. The concentration of the silver was 0.0095 mol/L, and the concentration of ammonium hydroxide was 0.095 mol/L, so that the NH₄0H/Ag molar ratio was 10.0. The silver solution was added to the aluminum oxide slurry at a rate of 4 ml/minute. The second feed was a 100 ml solution of hydrazine in water (0.14 mol/L N₂H₄), such that the N₂H₄/Ag molar ratio was 15.0, which was added at a rate of 4 ml/minute. The total time of addition plus additional recirculation was 30 minutes. The product was filtered, washed with water to form a wet cake, and dried in an oven at 110° C. A portion of the dried product was submitted for X-ray analysis and identified as silver on alpha alumina. Conventional synthesis was performed in the same manner as above except in a stirred 1500 ml beaker.

The data in Table 4 shows that the cavitational synthesis using an orifice size of 0.073 in. diameter and a 10/1 NH₄0H/Ag ratio resulted in much smaller grain sizes of Ag as compared to the conventional synthesis.

TABLE 4
Grain sizes (nm) of 2% silver on alumina

| 2% Ag/alumina | 10:1 NH₄OH:Ag |
|---|---|
| Conventional Synthesis | 20.9 nm grains |
| CaviMax 0.073 in. dia. | 14.0 nm grains |

### EXAMPLE 12

Nanostructured particles of gold supported on titania were also synthesized in accordance with the present invention. 650 ml of deionized water was recirculated in the CaviMax processor equipped with a 0.075 inch diameter orifice. A 100 ml solution of titanium (IV) butoxide in isopropyl alcohol (0.88 mol/L Ti) was added to the CaviMax at 4 ml/minute to form a precipitate. The total time of precipitation plus additional recirculation was 37.75 minutes. Two solutions were added simultaneously to the recirculating, precipitated titanium slurry. The first solution consisted of a 1L gold solution of chloroauric acid in deionized water (HAuCl₄·3H₂O) (0.0073 mol/L Au), which was added at a rate of 4.7 ml/minute. The second feed was a 100 ml solution of hydrazine in water (0.12 mol/L N₂H₄), such that the N₂H₄/Au molar ratio was 16.7, which was added at a rate of 0.4 ml/minute. The total time of addition plus additional recirculation was 3.62 hours. The product was filtered, washed with water to form a wet cake, and dried in an oven at 110° C. A portion of the dried product was calcined in air for 4 hours at 400° C. A portion of the calcined product was submitted for X-ray analysis and identified as gold on titania (anatase). X-ray line broadening analysis indicated that the mean gold grain size was 7.5 mn, and that the mean anatase grain size was 12.9 nm. Conventional synthesis was prepared in the manner above except in a stirred 1500 ml beaker.

The data in Table 5 shows that cavitational processing during the synthesis of 2% w/w of gold on titania results in systematically decreasing grain sizes into the very small manometer size range. This example shows that the combination of orifice size selection and process parameters afford a control of grain sizes not possible with conventional synthesis.

TABLE 5
Grain size as a function molarity of HA₄Cl₄.3H₂O solution

| | Volume of | | Titania | Gold grain |
|---|---|---|---|---|
| HA₄Cl₄.3H₂O | HA₄Cl₄.3H₂O | N₂H₄ feed rate | grain size | size |
| (mol/L) | (mL) | (mL/min) | (nm) | (nm) |
| 0.0145 | 50 | 8.0 | 12.5 | 78.6 |
| 0.0073 | 100 | 4.0 | 11.6 | 33.6 |
| 0.0036 | 200 | 2.0 | 11.4 | 27.9 |
| 0.0018 | 400 | 1.0 | 12.0 | 16.0 |
| 0.0007 | 1000 | 0.4 | 12.9 | 7.5 |

Where cavitation synthesis gave a 16 nm Au grain size, conventional synthesis resulted in a grain size of 25 nm. Where cavitation synthesis gave a 7.5 nm Au grain size, conventional synthesis gave a grain size of 23 nm.

### EXAMPLE 13

Piezoelectric solid state materials (“PZT”) were also prepared in accordance with the present invention in very high phase purities at low thermal treating temperatures.

TABLE 6
Preparation of PZT in different stoichiometries

| Ratio | ZrBut | TiBut | Sum |
|---|---|---|---|
| Zr:Ti | [ml] | [ml] | Formula |
| 30:70 | 15 | 35 | Pb(Zr_{0.3}Ti_{0.7})O₃ |
| 40:60 | 20 | 30 | Pb(Zr_{0.4}Ti_{0.6})O₃ |
| 50:50 | 25 | 25 | Pb(Zr_{0.5}Ti_{0.5})O₃ |
| 60:40 | 30 | 20 | Pb(Zr_{0.6}Ti_{0.4})O₃ |

PZT. 105.95 g (0.279 mol) of lead (II) acetate trihydrate (PbAc) was dissolved in IL deionized water. 100 g (0.279 mol) of titanium butoxide (TiBut, 97%) was diluted with 2-propanol to 500 ml. 132.58 g (0.279 mol) zirconium-butoxide-butanol complex (ZrBut, 80%) was diluted with 2-propanol to 500 ml. 2.74 g (0.0285 mol) of ammonium carbonate (Amm) was solved for each run in 350 ml water to give a 0.0814 M solution. The detailed stoichiometric information for this series is given in Table 6. The ammonium carbonate solution was placed in the reservoir and circulated. The Zr and Ti solutions were combined and fed at a rate of 2.5 ml/minute into the reservoir stream at a position just before the inlet to the high pressure pump. The Pb—Ac solution was co-fed with a rate of 5 ml/minute. All of the metal containing components immediately precipitated and were drawn into the high pressure zone of the cavitation processor and passed into the cavitation generation zone. All samples were dried over night and calcined in three steps for four hours at 400° C., 500° C. and 600° C. XRD patterns confirm that a calcination temperature above 500° C., only the pure perovskite phase is formed (with no lead oxide or zirconium oxide impurities). The XRD patterns contains some finer crystallites of this material appearing as a broad band centered at 30° 2θ. This material disappears from the composition after calcination to 600° C.

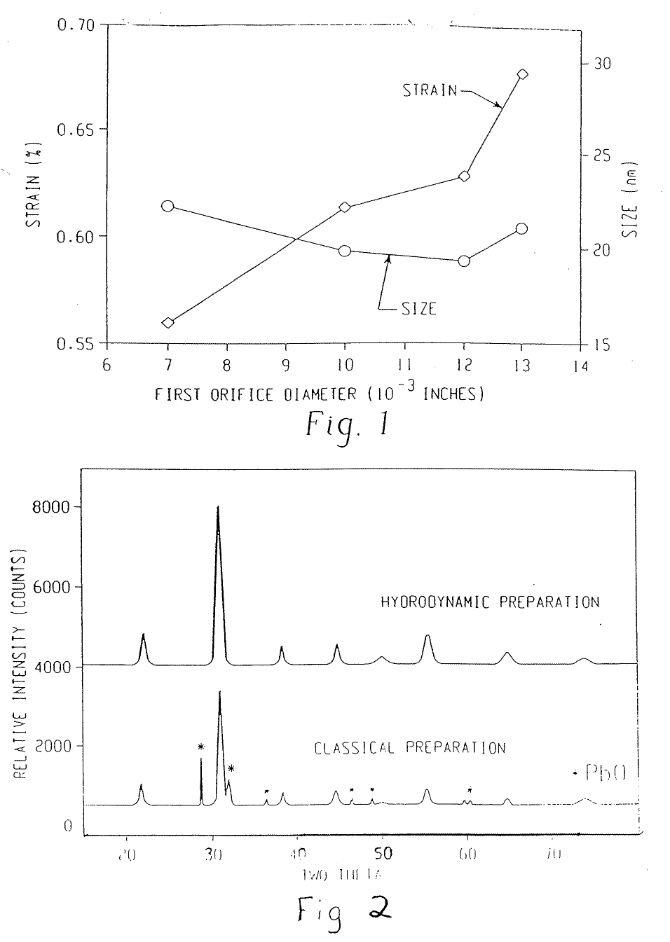

The data in FIG. 1 illustrates that the hydrodynamic cavitation technique embodied herein enables the synthesis of piezoelectrics in compositions having a very high degree of crystallographic strain built into the individual graines. Furthermore, FIG. 1 shows that the degree of crystallographic strain can be systematically introduced into the grains as a function of the type of orifice used in the synthesis. It was found that the degree of strain introduced by cavitation was much greater than that found in a classical method of piezoelectric synthesis of the same composition.

The data in FIG. 2 illustrates the advantage of cavitational processing in piezoelectric synthesis by a direct comparison to a classical co-precipitation synthesis. The top XRD pattern in FIG. 2 resulted from a cavitational preparation after 600° C. air calcination. The lower figure resulted from a classical co-precipitation carried out using the same synthesis procedure, except that only high speed mechanical stirring was used in the coprecipitation step rather than cavitational processing. A comparison of the two XRD patterns shows that the classical pattern has a substantial fraction of separate phase lead oxide while the cavitational preparation has no secondary phase in its composition. This higher phase purity is exceptionally important to the functioning of the materials as a piezoelectric device.

### EXAMPLE 14

The data in Table 7 illustrates the capability of the present invention to form nanostructured grains of finely divided metals typically used commercially to hydrogenate aromatics and functional groups on organic intermediates in fine chemical and pharmaceutical chemical processes. 0.465 g of hexachloroplatinic acid was dissolved in 50 ml of isopropanol. The platinum solution was fed to a stirred Erlenmeyer flask containing 0.536 g of hydrazine hydrate in 50 ml of isopropanol. The platinum solution feed rate was 5 ml/minute. The solution was fed to the CaviPro processor, and processed for 20 minutes. The dried powders were subjected to XRD.

TABLE 7
Effect of pressure and orifice sizes on the
synthesis of nanostructured platinum

| Orifice set | Pressure | Pt metal grain size (nm) |
|---|---|---|
| .004/.014 | 25,000 psi | 3.9 |
| .004/.006 | 25,000 psi | 3.7 |
| .004/.014 | 15,000 psi | 4.1 |
| .004/.006 | 15,000 psi | 3.9 |
| Classical | 14.7 psi | 5.4 |

### EXAMPLE 15

In accordance with the present invention, silver on α-alumina catalysts were also prepared in the production of ethylene oxide from the partial oxidation of ethylene. The data in Table 8 illustrates the XRD determined grain sizes of the silver particles which had been deposited onto α-alumina during the cavitational synthesis in which the silver was reduced in a cavitation experiment and then deposited onto the α-alumina in water using classical techniques. The data shows that changing the orifice sizes used in each experiment can alter the grain size of the silver. The characteristics of the different orifice sizes are expressed as the throat cavitation numbers calculated for each experiment, which is a common reference for the occurrence of cavitation in flowing fluid streams. Using this method of characterization, the cavitation generated in the metal synthesis stream is higher as the throat cavitation numbers decreases.

2% silver on a-alumina was prepared by the reduction of silver acetate with hydrazine. This reduction was conducted in the CaviPro processor at a pressure of 15,000 psi, followed by a classical adsorption/deposition of an aqueous slurry of silver particles onto an α-alumina support. The number of passes of the medium for each consecutive experiment was fixed, and the feed flow rates and processing time were adjusted accordingly. The total number of passes for this series of experiments was held constant at 17.6. Experiments were conducted at varying throat cavitation number, by varying the size of the first orifice. The results are shown in Table 8 below.

TABLE 8
Variation in silver particle grain sizes

| Orifice Sets | Throat Cavitation Number | Silver |
|---|---|---|
| in./in. | (calculated) | Grain size (nm) |
| 0.005/0.014 | 3.07 | 16.00 |
| 0.007/0.014 | 4.36 | 21.00 |
| 0.009/0.014 | 5.46 | 19.20 |
| 0.011/0.014 | 7.93 | 17.30 |

### EXAMPLE 16

The degree of in situ calcination was also examined. Four separate samples of solid ammonium molybdate were calcined for four hours in air to 100° C., 175° C., 250° C. and 325° C. XRD data was taken for each sample. A fifth sample of ammonium molybdate was dissolved in water and fed into an isopropyl alcohol solution just before it passed into the CaviPro processor using a 0.012/0.014 inch orifice set. The sample was filtered and dried at 100EC. XRD data was obtained for this sample. A comparison of the XRD patterns showed that the fifth sample had a degree of calcination greater than the sample calcined at 100° C., and about equal to that of the 175° C. sample. Considering the residence time of milliseconds for the present invention as compared to 4 hours for the conventional method, the use of the present invention resulted in a high level of in situ thermal calcination.

### EXAMPLE 17

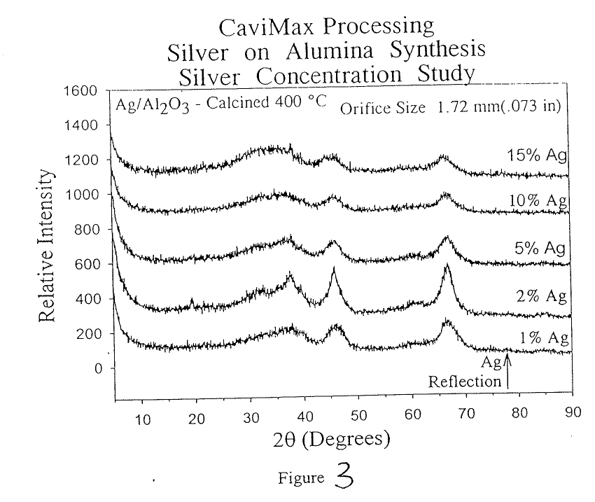

To evaluate the effect of silver concentration on grain size, a series of silver on alumina catalysts were synthesized, with varying concentrations (1%, 2%, 5%, 10%, and 15 wt % Ag on Al₂O₃). 20.44 g of aluminum isopropoxide in 100 mL cyclohexane solution was added to 600 mL of water, and was recycled in the CaviMax (0.075 inch orifice). After 5 minutes of processing, hydrazine was added in a silver to hydrazine ratio of 1:1. After five minutes of processing, a 400 ml silver acetate solution was fed to the CaviMax processor (40 mL/min.). The product was processed for 10 minutes (total synthesis time was 30 minutes). The product was pressure filtered, washed with 150 ml isopropanol (to remove the cyclohexane), and washed twice with 150 mL DI-H₂O. The samples were dried overnight at 105° C. The Ag/Al₂O₃ samples were calcinated for six hours at 400° C. After calcination, the samples were analyzed using XRD. These results are shown in FIG. 3. The XRD of the 400° C. calcined material show virtually no reflection for metallic silver, indicating that the particles are exceptionally well dispersed. The broad envelope that arises near 35° 2θ could be due to the formation of silver oxide. It is known that silver oxide decomposes at 300° C. Thus, if all of the silver has been converted to silver oxide, it consists of very small grain sizes and must be strongly interacting with the aluminum oxide support. The literature reports that a high temperature form of silver oxide may be synthesized, but the literature report indicates that this oxide is normally able to be formed only at temperatures above 1600 K. The unusual behavior of these materials indicates that the silver component must be formed in very small grains and has provided a catalyst structure which is much different from that of literature reported forms of silver on alumina. This catalyst should be very effective in the environmental catalysis area and useful for the reduction of nitric oxide by hydrocarbons. The fact that a high temperature, stable form of silver oxide is obtained in these catalysts may be especially useful for the nitric oxide reduction reaction.

### EXAMPLE 18

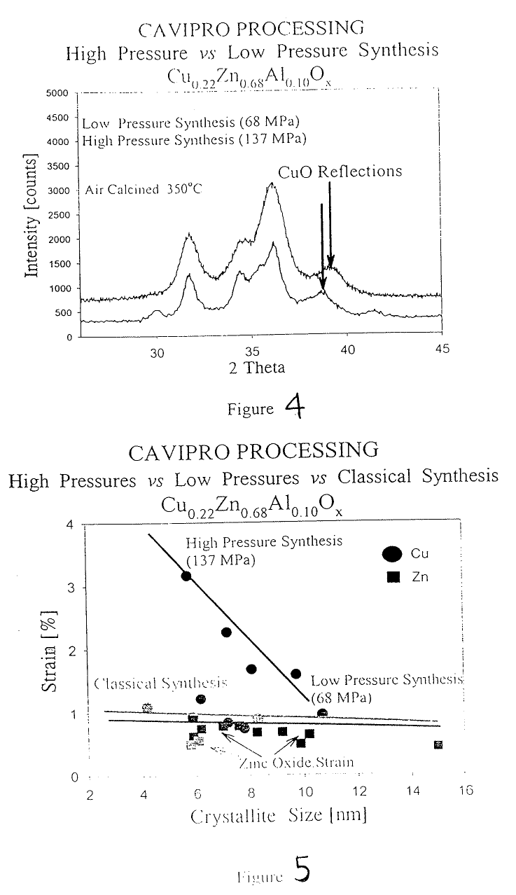

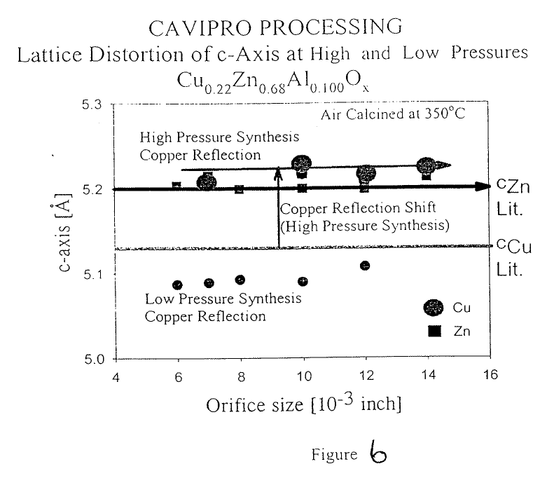

Copper modified zinc oxide, which is useful as a catalyst for the synthesis of methanol, was also prepared in accordance with the present invention. A series of experiments was performed precipitating Cu_{0.225}Zn_{0.675}Al_{0.1}·37.514 g (0.1 mol) Al(NO₃)₃. 9H₂O, 60.40 g (0.225 mol) of Cu(NO₃)₃. 3H₂O and 124.353 g (0.675 mol) Zn(NO₃)₃ XH₂O in 1 L deionized water. 0.553 were dissolved (NH₄)₂CO₃ and 1.0 M Na₂CO₃ solutions were used as precipitating agents. The amount on carbonates used was determined experimentally to obtain a pH value of 8. Two different series were performed in the CaviPro processor. The first series was performed using (NH₄)₂CO₃ at a constant pressure of 10,000 psi with the orifices 6-14, 7-14, 8-14, 10-14 and 12-14 (the “Low Pressure Experiments”). The second series was performed using Na₂CO₃ at a constant pressure of 20,000 psi with the orifices 6-7, 6-10, 6-12 and 6-14 (the “High Pressure Experiments”). All samples were washed with water, filtered, dried at 100° C. overnight and calcined at 350° C. for four hours. XRD was taken and the standard investigations were performed. All X-ray patterns were identified as a mixture of ZnO and CuO. Additionally, residual Na₂CO₃ was detected for the second series, which was not removed totally with the washing procedure. FIG. 4 reveals a typical diffractogram. Another important feature of the experimental results is shown in FIG. 5. The data in this figure indicate that the cavitation processing experiments resulted in different grain sizes of the active component, CuO, and that the strain increased as the grain sizes decreased. Furthermore, the classically prepared materials all showed a very low degree of strain.

The analysis of the lattice constants for both oxides shows some very unusual results for methanol synthesis catalysts as judged from prior literature synthesis of this type of catalyst. FIG. 6 shows that the lattice spacing for the c-axis direction in CuO has been shifted to an unusually high value as compared to conventional catalysts for the high pressure experiments. The c axis of the copper oxide is shifted in the high pressure experiment to the same value as that of the zinc oxide. This distortion of the unit cell is very unusual and causes the much larger strain detected in CuO in this system. Furthermore, these results indicate epitaxial growth of CuO on ZnO and a novel structure for this type of catalyst. This is potentially important for the activity of this material in methanol synthesis catalysts. Epitaxy is the growth of a solid compound (here CuO), which tries to imitate the structure of the substrate (ZnO). Due to the different preferred geometric arrangements of Cu²⁺ (square planar) and Zn²⁺ (tetrahedral), it is not possible for one of the species to completely mimic the other. Thus, a 2-dimensional super lattice exists. The transition from the C₄O layer to the ZnO can be considered as an interlayer, which has in the lower plane Zn atoms. The next plane layer is a layer of oxygen atoms, followed by the first layer of Cu atoms. This is a novel structure for a Cu—Zn—Al—O methanol synthesis catalyst and may have important implications in catalytic evaluations. Furthermore, the data in FIG. 5 shows that the copper oxide component can be synthesized in systematically varying grain sizes.

### EXAMPLE 19

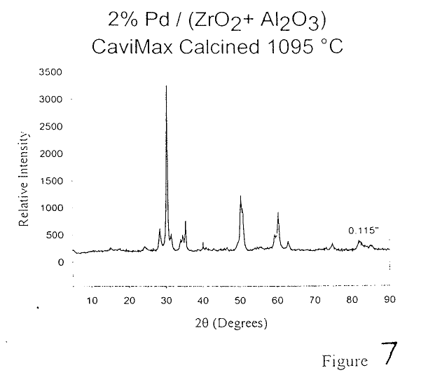

A series of 2% palladium on alumina/zirconia (10%/90%) support were synthesized to produce a catalyst with high surface area, and small metal grain size that is stable up to high temperatures (1200° C.). It has been suggested that the alumina acts as a barrier that prevents phase transformation of the zirconia support, and thereby regaining small grain size support and prevention of sintering of the palladium. Four samples were synthesized in the CaviMax processor (0.073″, 0.081″, 0.095″, and 0.115″), as well as a classical precipitation. 100 mL of a palladium nitrate solution and 100 mL of a hydrazine hydrate solution were added to a 700 mL water recycle in the CaviMax processor. This mixture was processed for 30 minutes, after which a zirconium n-butoxide/aluminum isopropoxide in n-hexane solution was added to the synthesis solution. This new solution was processed for an additional 20 minutes, after which the samples were pressure filtered and washed. The 1095° C. air calcined material using the 0.115″ orifice in the CaviMax processor is shown in FIG. 7. The important aspect of this result is that a palladium supported catalyst was synthesized where high temperature calcination did not cause the catalyst to densify to a large grain material, which would be expected to have a very low surface area. This type of high temperature stable catalyst is expected to have commercial application in turbine combustion used by power companies to generate electricity.

While various embodiments of the present invention have been disclosed, it should be understood that modifications and adaptations thereof will be obvious to persons skilled in the art. The compositions of the present invention, as well as the methods of forming those compositions, can be extended to a number of uses and applications. Other features and aspects of this invention will be appreciated by those skilled in the art upon reading and comprehending this disclosure. Such features, aspects, and expected variations and modifications of the reported results and are clearly within the scope of the invention and the invention is limited solely by the scope of the following claims.

1-10. (canceled)

11. A metal-based material, comprising:
one or more metals having a grain size of about 1 to about 200 nanometers, wherein the metal based material has a crystallographic strain of about 0.1% to about 5.0% and is of a high phase purity.

12. The material of claim 12, wherein the metal containing solution includes a metal salt.

14. The material of claim 13, wherein the metal salt includes one or more of nitrate, acetate, chloride, sulfate, bromide, and mixtures thereof.

15. The material of claim 13, wherein the metal in the metal containing solution includes one or more of cobalt, molybdenum, bismuth, lanthanum, iron, strontium, titanium, silver, gold, lead, platinum, palladium, yttrium, zirconium, calcium, barium, potassium, chromium, magnesium, copper, zinc, and mixtures thereof.

16. The material of claim 11, wherein the high phase purity includes a purity higher than that of the same metal based material prepared by a classical co-precipitation synthesis.

17. The material of claim 11, including one or more metals having a crystalline grain size of about 1 nm to about 20 nm.

18. The material of claim 11, wherein the metal-based material includes one or more of, nanostructured materials, solid state materials, metal supported materials, and catalysts.

19. The material of claim 11, wherein the metal-based material comprises one or more of, catalysts, capacitors, piezoelectric materials, titanias, superconductors, electrolytes, ceramic based products, oxides, zeolites, and fine grains of slurries of finely divided reduced metals.

20. The material of claim 11, wherein the one or more metals are deposited on a solid support.

21. The material of claim 11, wherein the metal-based material has a crystallographic strain of about 0.5% to about 0.7%.

22. A material formed by cavitation, the material comprising:
a metal having a crystalline grain size of about 1 nm to about 20 nm, a phase purity higher than that of a material formed by a classical co-precipitation synthesis, and a crystallographic strain of about 0.1% to about 5.0%; and
wherein the metal includes one or more of, cobalt molybdenum, bismuth, lanthanum, iron, strontium, titanium, silver, gold, lead, platinum, palladium, yttrium, zirconium, calcium, barium, potassium, chromium, magnesium, copper, zinc, and mixtures thereof.

23. The material of claim 22, wherein the material has a crystallographic strain of about 0.5% to about 0.7%.

24. The material of claim 22, wherein the material is one or more of a nanostructured catalyst, solid state material, and metal supported catalyst.

25. A metal-based material comprising:
one or more metals having a grain size of about 0.1 nm to about 100 nm, wherein the metal based material has a crystallographic strain of about 0.1% to about 5.0% and is of a phase purity higher than that of a metal based material prepared from the same starting materials and formed by a classical co-precipitation synthesis;
wherein the metal-based material includes one or more of nanostructured materials, solid state materials, metal supported materials, and catalysts; and
wherein at least one of the metals includes one or more of cobalt, molybdenum, bismuth, lanthanum, iron, strontium, titanium, silver, gold, lead, platinum, palladium, yttrium, zirconium, calcium, barium, potassium, chromium, magnesium, copper, zinc, and mixtures thereof.

26. The material of claim 25, wherein the metal supported materials includes one or more metals deposited on a solid support, the solid support including one or more of alumina, silica, titania, zirconia, and alumino-silicates.

27. The material of claim 25, wherein the metal-based material includes a silver on alumina catalyst including about 1 wt % to about 15 wt % silver, and wherein the grain size of the silver is less than about 15 nm.

28. The material of claim 25, wherein the metal-based material includes a copper modified zinc oxide catalyst, where the grain size is about 5 nm to about 12 nm and the catalyst has a crystallographic strain of about 1% to about 4%.

29. The material of claim 25, wherein the metal-based material includes a palladium on aluminum-zirconia catalyst, including a palladium component deposited on an alumina/zirconia support, wherein the palladium component has an average grain size of less than 1 nm, and wherein the catalyst is stable at temperatures less than about 1200° C.

30. The material of claim 25, wherein the metal-based material includes one or more of cobalt molybdate on gamma-alumina catalyst, cobalt molybdate on silica catalyst, bismuth molybdate catalyst, silver on titania catalyst, gold on titania catalyst, and piezoelectric material.

31. The material of claim 25, wherein the metal-based material has a crystallographic strain of about 0.5% to about 0.7%.
